(19) United States
(12) Patent Application Publication
(10) Pub. No.: US 2024/0214021 A1
(43) Pub. Date: Jun. 27, 2024

(54) SYSTEMS AND METHODS FOR ANTENNA OBSTRUCTION DETECTION AND MITIGATION

(71) Applicant: Apple Inc., Cupertino, CA (US)

(72) Inventors: Aditya N. Srivastava, Fremont, CA (US); Thomas E. Biedka, San Jose, CA (US); Tianchang Gu, San Jose, CA (US); Apexit Shah, Santa Clara, CA (US)

(21) Appl. No.: 18/087,396

(22) Filed: Dec. 22, 2022

(51) Int. Cl. H04B 1/3827; H04B 1/401

(52) U.S. Cl. CPC H04B 1/3838; H04B 1/401

(57) ABSTRACT

Obstruction detecting logic may execute touch-sensing algorithms on the electronic device, which may detect when a user is gripping the electronic device from the side, when the fingers or hand of the user is on the edge of the electronic device, when the user is using one or more fingers to touch the electronic device, and may determine thumb and finger orientation. Using the touch-sensing methods, it may be determined which antennas are obstructed. To mitigate negative antenna performance due to the determined obstruction, one or more compensation actions may be taken. The touch-sensing algorithms may estimate user thumb/finger orientation and velocity, which may be used to predict future antenna occlusion (e.g., if the hand of the user is in motion).

### BACKGROUND

The present disclosure relates generally to wireless communication, and more specifically to detection and mitigation of antenna obstruction in wireless communication devices.

Performance of a wireless communication device may be affected by obstruction of one or more antennas of the wireless communication device. A degree of antenna obstruction may depend on a variety of factors, such as a position in which a user is holding and/or interacting with the wireless communication device. Some techniques for addressing antenna obstruction may include determining a wireless signal characteristic (e.g., signal power or quality), determining a rate of change of the wireless signal characteristic, or determining a device posture or orientation. However, these techniques may not account for changes in wireless signal characteristic due to channel conditions, radio frequency (RF) losses in the front end of the wireless communication device that may affect signal magnitude thresholds, and/or specific user behavior relating to how the wireless communication is held, among other considerations.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a device includes a plurality of touch sensors, one or more antennas, and processing circuitry coupled to the plurality of touch sensors and the one or more antennas. The processing circuitry may receive touch sensor data from the plurality of touch sensors, receive an indication of device interaction, and perform an action based on a prediction of antenna occlusion based on the indication of device interaction, wherein the action is configured to mitigate effects of the antenna occlusion.

In another embodiment, a method includes receiving, via antenna obstruction detecting logic, touch sensor data from an electronic device, receiving at the antenna obstruction detecting logic, a usage pattern based on the touch sensor data, and performing, via a processor, one or more actions based on a prediction of antenna occlusion based on the usage pattern, the one or more actions configured to mitigate effects of the antenna occlusion.

In yet another embodiment, a tangible, non-transitory, computer-readable medium includes computer-readable instructions that cause one or more processors to receive calibration data corresponding to antenna occlusion, receive touch sensor data from a plurality of touch sensors, receive an indication of a device interaction, predict antenna occlusion based on the indication and the calibration data, and execute a preventative measure to reduce or eliminate effects of the antenna occlusion.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a schematic diagram illustrating example locations of antennas in the electronic device;

FIG. 6 is a perspective diagram of a user holding the electronic device of FIG. 1 in an orientation corresponding to interacting with and/or selecting a mobile application;

FIG. 7 is a perspective diagram of the user holding the electronic device of FIG. 1 in their hands in another orientation corresponding to mobile gaming;

FIG. 8 is a perspective diagram of the user holding the electronic device of FIG. 1 in yet another orientation corresponding to making a voice call;

FIG. 9 is a flowchart of a method for determining and mitigating the effects of antenna obstruction, according to embodiments of the present disclosure;

FIG. 10 illustrates example touch sensor readings based on playing a mobile game on the electronic device of FIG. 1, according to embodiments of the present disclosure;

FIG. 11 illustrates example touch sensor readings based interacting with and/or selecting a mobile application of the electronic device of FIG. 1, according to embodiments of the present disclosure;

FIG. 12 illustrates example touch sensor readings based on making a voice call on the electronic device of FIG. 1, according to embodiments of the present disclosure;

FIG. 13 is a flowchart of a method for predicting an upcoming user interaction with the electronic device and performing mitigating actions to reduce or eliminate negative impacts of antenna obstruction, according to an embodiment of the present disclosure; and

FIG. 14 illustrates predicted touch sensor readings based on current touch sensor readings, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to detecting antenna obstructions in an electronic device and mitigating or minimizing the impacts to communication performance due to the obstruction or occlusion. User experience and performance of the electronic device may be affected by antenna obstruction. The degree of antenna obstruction may depend on a variety of factors, such as the position in which a user is holding and/or interacting with the electronic device. The position of the user's hand and/or body may degrade the strength and/or quality of a wireless signal received or transmitted through the antenna. In some cases, certain techniques may be used to determine antenna obstruction estimates based on indirect observations, such as determining a wireless signal characteristics, determining a rate of change of the wireless signal characteristic (e.g., signal power or quality), or determining electronic device posture or orientation (e.g., determining that the electronic device is in a user's hand, that the user is viewing content on the electronic device, and so on).

However, determining antenna obstruction estimates based on indirect observations may have drawbacks, such as when the characteristic of the wireless signal changes due to channel conditions (e.g., channel obstruction due to a tree, a building, atmospheric conditions, and so on) and not only due to hand/body obstruction, RF losses in the front end of the electronic device affect signal magnitude thresholds before a signal strength measurement, when device posture does not take into account user specific behavior when the device is held (e.g., the user is using or holding the electronic device in a manner different from general expectation), and so on. Such antenna obstruction estimations based on indirect observations and/or determinations may be less accurate, may result in greater delays in determining antenna obstruction, and may not be useful in accurately determining upcoming obstructions estimates, among other disadvantages. Further, delay may increase as these methods rely on antenna obstruction impact to propagate or device mode use patterns to change prior to generating accurate upcoming obstruction estimates.

In some embodiments, antenna obstruction detecting logic may use touch sensors and touch-sensing algorithms of the electronic device, which may detect, with very low latency, when the user is gripping the electronic device from the side (or has gripped the electronic device from the side some threshold amount of time in the past), when the user is straddling fingers on the edge, when the user is using one or more fingers to touch the electronic device, thumb and finger orientation, and so on. The touch-sensing algorithms may precisely define (e.g., in two-dimensional (2D) space) where the touch/grip of the user is with respect to the electronic device and the antennas disposed on the electronic device. Using the touch-sensing methods, there may be little ambiguity as to which antennas are being obstructed, in contrast to the indirect methods discussed above. The touch-sensing algorithms may operate in a range of 40 hertz (Hz) to 120 Hz, which may provide sub-second gathering times for antenna obstruction information. The touch-sensing algorithms may execute when a display of the electronic device is on or off. In one or more embodiments, the touch-sensing algorithms may estimate user thumb/finger orientation and velocity, which may be used to predict future antenna occlusion (e.g., if the user's hand is in motion).

Antenna obstruction detecting circuitry (e.g., hardware, firmware, and/or software executed on dedicated or general-purpose hardware) of the electronic device may determine which antenna(s) are obstructed and perform actions or execute preventative measures that may mitigate, reduce, minimize, or eliminate the undesirable impacts of the obstruction. For instance, the antenna obstruction detection circuitry may switch from an obstructed antenna to a unobstructed antenna; manage antenna tuner settings to prioritize the unobstructed antenna; manage antenna tuner settings to adjust the values of variable transceiver circuit components (e.g., adjusting the capacitance of one or more variable capacitors of antenna tuner or transceiver circuitry, adjusting the inductance of one or more variable inductors of antenna tuner or transceiver circuitry, and so on); manage antenna tuner settings to adjust the frequency at which the antenna transmits and/or receives signals; increase power to one or more unobstructed antennas or signal processors corresponding to the one or more unobstructed antennas, manage antenna tuner to switch to a different RF channel and/or RF band (e.g., frequency range) that may correspond to greater antenna efficiency; reduce power to one or more obstructed antennas or signal processors corresponding to the one or more obstructed antennas until the antennas becomes less obstructed or unobstructed if alternate antenna paths and/or tuner options do not improve signal strength; perform other technology tradeoffs internally for the user without negatively impacting user experience; switching the electronic device to a different radio access technology (e.g., Long Term Evolution (LTE®) cellular network, New Radio (NR) cellular network. Frequency Range 1 (FR1) cellular network, Frequency Range 2 (FR2) cellular network, and so on); alert the user to possible postures or holds that may improve antenna performance; and/or gather statistics on user grip/usage patterns for better antenna placement/design in the future.

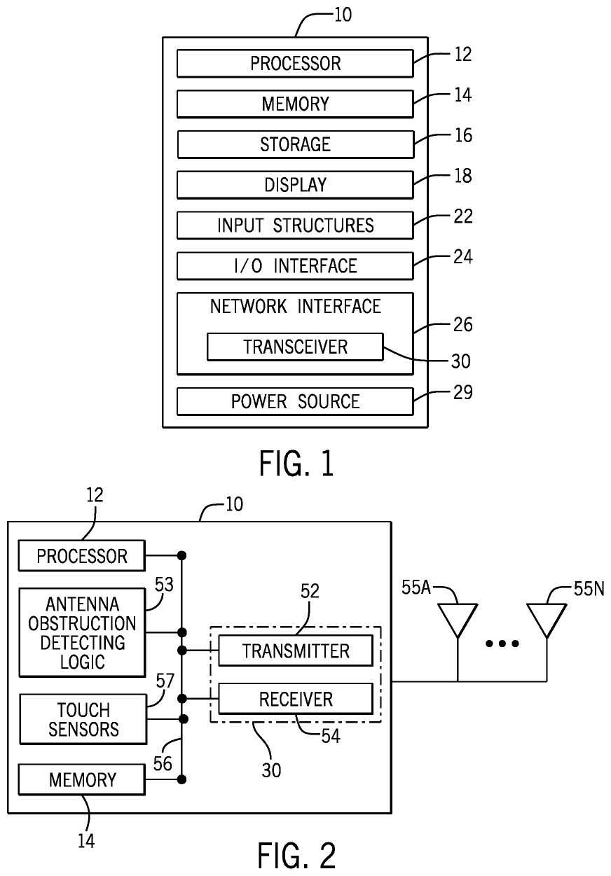

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device. including a desktop or notebook computer (e.g., in the form of a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (e.g., in the form of a model of an iPhone® available from Apple Inc. of Cupertino, California), a tablet (e.g., in the form of a model of an iPad® available from Apple Inc. of Cupertino, California), a wearable electronic device (e.g., in the form of an Apple Watch® by Apple Inc. of Cupertino, California), and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE®) cellular network. Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, antenna obstruction detecting logic 53, touch sensors 57, the processor 12, the memory 14, the transceiver 30, a transmitter 52, a receiver 54, and/or antennas 55 (illustrated as 55A-55N, collectively referred to as an antenna or antennas 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

The antenna obstruction detecting logic 53 may include software (e.g., instructions executable by the processor 12 or dedicated hardware components), hardware (e.g., circuitry, which may include the processor 12), or both (e.g., in the form of logic). The touch sensors 57 may be disposed within the electronic device 10 (e.g., under the display 18 or in the bezel) and may detect, with very low latency (e.g., at a range of 40 hertz (Hz) to 120 Hz), when the user is gripping the electronic device 10 from the side (or has gripped the electronic device from the side some threshold amount of time in the past), when the user is straddling fingers on the edge of the electronic device 10, when the user is using one or more fingers to touch the electronic device 10 (e.g., touch the display 18, the bezel, and so on), thumb and/or finger orientation, and so on. The antenna obstruction detecting logic 53 may utilize the data of the touch sensors 57 and/or touch-sensing algorithms to define (e.g., in 2D space) where the touch/grip of the user is with respect to the electronic device 10 and the antennas 55 disposed on the electronic device 10.

By using the data from the touch sensors 57, the antenna obstruction detecting logic 53 may reduce or eliminate ambiguity as to which of the antennas 55 are being obstructed. The touch-sensing algorithms of the antenna obstruction detecting logic 53 may operate at 40 Hz or greater (e.g., 60 Hz, 100 Hz, 120 Hz, 180 Hz, and so on), which may provide sub-second gathering time for antenna obstruction information. The antenna obstruction detecting logic 53 may execute when the display 18 is on or off. In one or more embodiments, the antenna obstruction detecting logic 53 may estimate and/or predict user hand/thumb/finger/head/face orientation and velocity, which may be used to predict future antenna occlusion or obstruction (e.g., if the user's hand and/or fingers are in motion). While the antenna obstruction detecting logic 53 may detect movement and/or placement of the hands, fingers, thumbs, head, face, and so on, such movement and/or placement will be referred to herein as hand placement for convenience and simplicity.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

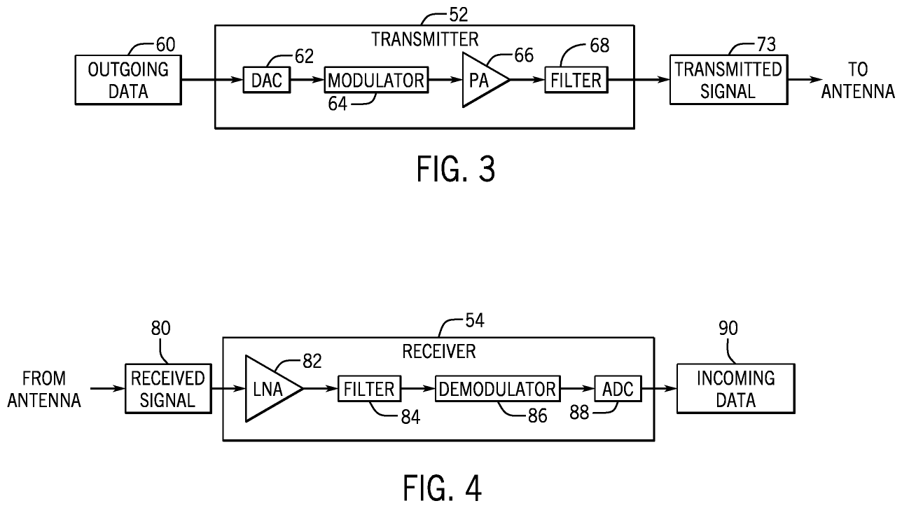

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10.

A demodulator 86 may remove a radio frequency envelope and/or extract a demodulated signal from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter.

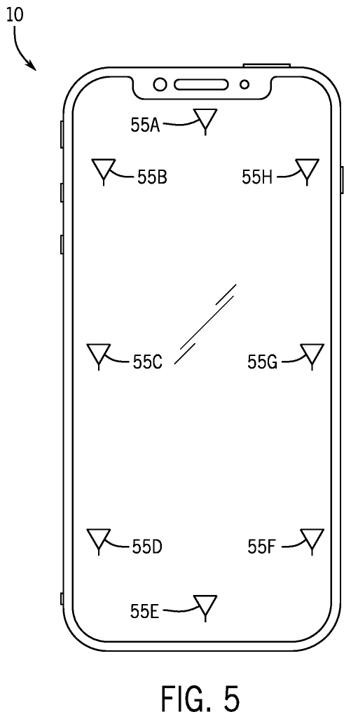

FIG. 5 is a schematic diagram illustrating locations of the antennas 55 on the electronic device 10. The antennas 55A, 55B, 55C, 55D, 55E, 55F, 55G, and 55H (collectively, the antennas 55) may be disposed on the periphery of the electronic device 10, as illustrated. However, in some cases, antennas may be at or near the center of the electronic device 10. As previously mentioned, user experience and performance of the electronic device may be affected by antenna obstruction. The degree of antenna obstruction may depend on a variety of factors, such as the position in which a user is holding and/or interacting with the electronic device. The placement of the user's hand and/or body may degrade the strength and/or quality of a wireless signal received or transmitted through the antenna. The number of antennas 55 shown in FIG. 5 is merely illustrative, and there may be more or fewer antennas 55 (e.g., 5 antennas or more, 10 antennas or more, 100 antennas or more, and so on).

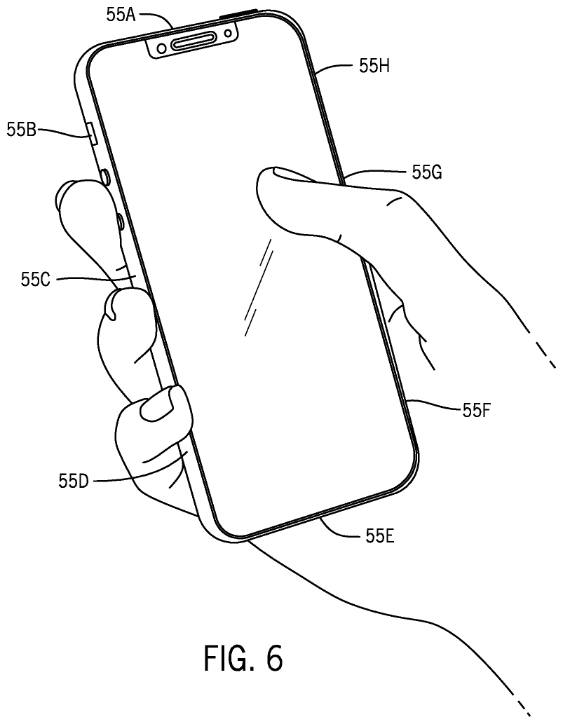

FIG. 6 is a perspective diagram of a user holding an electronic device (e.g., 10) in an orientation corresponding to a use case. The device usage/hand placement illustrated in FIG. 6 may correspond to usage or selection of certain mobile device applications or functionalities (e.g., a text messaging application, a banking application, a social media application, a videoconferencing application, and so on). For example, the hand placement illustrated in FIG. 6 may obstruct the antennas 55C, 55D, and 55E shown in FIG. 5.

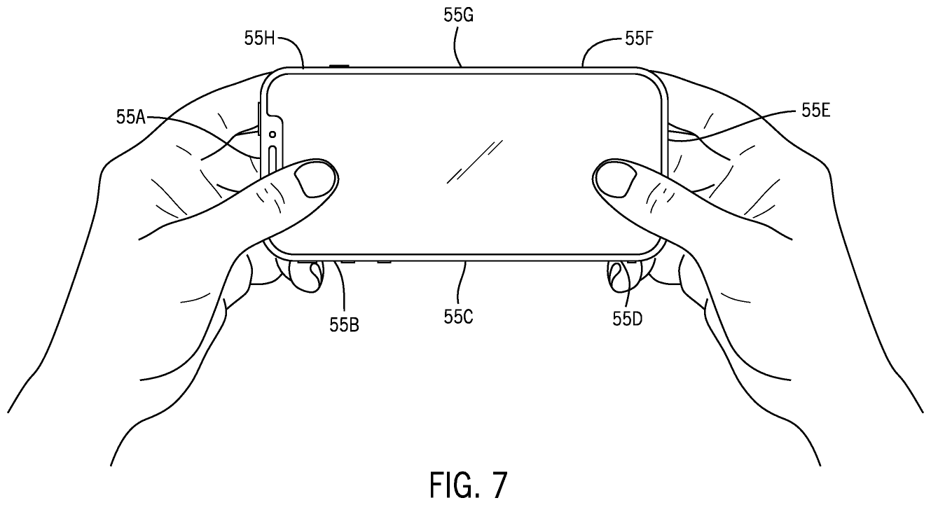

FIG. 7 is a perspective diagram of the user holding the electronic device 10 in their hands in another orientation corresponding to another use case. The device usage/hand placement illustrated in FIG. 7 may correspond to usage of certain mobile device applications (e.g., mobile gaming applications, a text messaging application, and so on). The hand placement illustrated in FIG. 7 may obstruct the antennas 55A, 55B, 55C, 55D, and 55E shown in FIG. 5, but leave antennas 55F, 55G, and 55H unobstructed or less obstructed.

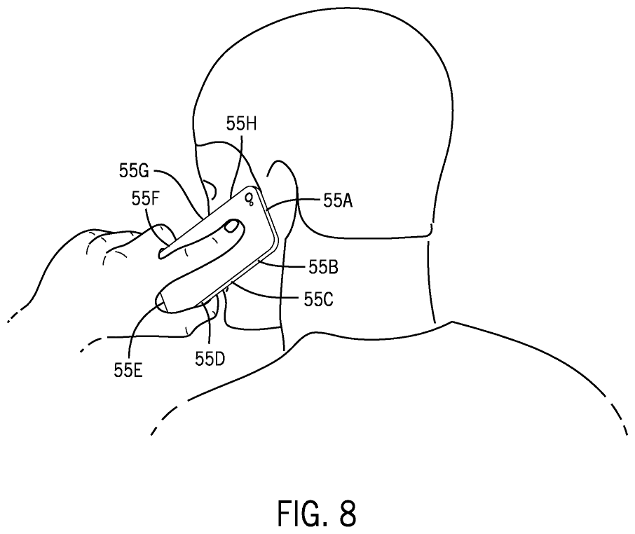

FIG. 8 is a perspective diagram of the user holding the electronic device 10 in their hand in yet another orientation corresponding to yet another use case. The device usage/hand placement illustrated in FIG. 8 may correspond to usage of certain mobile device applications or functionalities (e.g., a voice calling application, a speech-to-text application, and so on). For example, the hand placement illustrated in FIG. 8 may obstruct the antennas 55D, 55E, and 55F shown in FIG. 5, but leave the antennas 55A, 55B, 55C, 55F, and 55H unobstructed or less obstructed. FIGS. 6-8 are merely illustrative, and other hand placements, along with the corresponding usage, may be stored in a data structure (e.g., a lookup table) in memory 14 or storage device 16.

As mentioned above, in some embodiments, antenna obstruction detecting logic 53 may use touch sensors and touch-sensing algorithms on the electronic device 10, which may detect, with very low latency, when the user is gripping the electronic device from the side (or has gripped the electronic device from the side some threshold amount of time in the past), when the user is straddling fingers on the edge, when the user is using one or more fingers to touch the electronic device, may determine thumb and finger orientation, and so on.

The touch-sensing algorithms may precisely define (e.g., in two-dimensional (2D) space) where the touch/grip of the user is with respect to the electronic device 10 and the antennas 55 disposed on the electronic device 10. Using the touch-sensing methods, there may be little ambiguity as to which antennas 55 are being obstructed, in contrast to the indirect methods discussed above. The touch-sensing algorithms may operate in a range of 40 hertz (Hz) or greater (e.g., 40 Hz or greater, 60 Hz or greater, 100 Hz or greater, 120 Hz or greater), which may provide sub-second gathering times for antenna obstruction information. The touch-sensing algorithms may run when the display 18 is on or off. The touch-sensing algorithms may estimate user thumb/finger orientation and velocity, which may be used to predict future antenna occlusion (e.g., if the user's hand is in motion). The touch-sensing algorithms may be stored in the memory 14 and/or the storage device 16 (e.g., in the form of software) and may be executable by the processor 12.

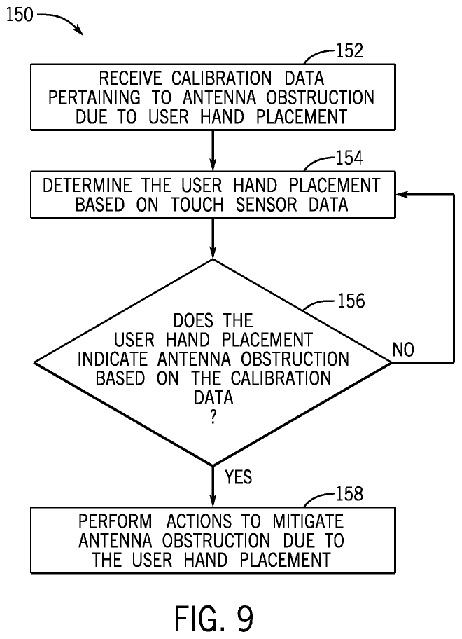

FIG. 9 is a flowchart of a method 150 for determining and mitigating the effects of antenna obstruction, according to embodiments of the present disclosure. Any suitable device (e.g., a controller) that may control components of the electronic device 10, such as the processor 12 and/or the antenna obstruction detecting logic 53, may perform the method 150. In some embodiments, the method 150 may be implemented by executing instructions stored in a tangible, non-transitory, computer-readable medium, such as the memory 14 or storage 16, using the processor 12. For example, the method 150 may be performed at least in part by one or more software components, such as an operating system of the electronic device 10, one or more software applications of the electronic device 10, and the like. While the method 150 is described using steps in a specific sequence, it should be understood that the present disclosure contemplates that the described steps may be performed in different sequences than the sequence illustrated. and certain described steps may be skipped or not performed altogether.

In process block 152, the antenna obstruction detecting logic 53 (which may include the processor 12) may receive calibration data pertaining to antenna obstruction due to user hand placement. The calibration data may be determined during manufacturing of the electronic device 10. For example. performance of the electronic device 10 may be tested and calibrated with various degrees of antenna obstruction, e.g., due to different hand placement/grip of the electronic device 10. For example, during manufacturing, the antenna obstruction due to the hand placements illustrated in FIGS. 6-8 may be measured and stored as calibration data. In some embodiments, the calibration data may be determined for a user-by-user basis. For example, upon powering on the electronic device 10, the processor 12 may prompt the user to hold or grip the electronic device 10 in a variety of hand placements (e.g., the hand placements discussed with respect to FIGS. 6-8). The processor 12 may record data from the touch sensors 57 corresponding to the variety of hand placements. The processor 12 may store the variety of hand placements and usages as the calibration data (e.g., in the memory 14 and/or the storage 16). The calibration data may be stored in a data structure (such as a lookup table) in the memory 14 and/or storage 16.

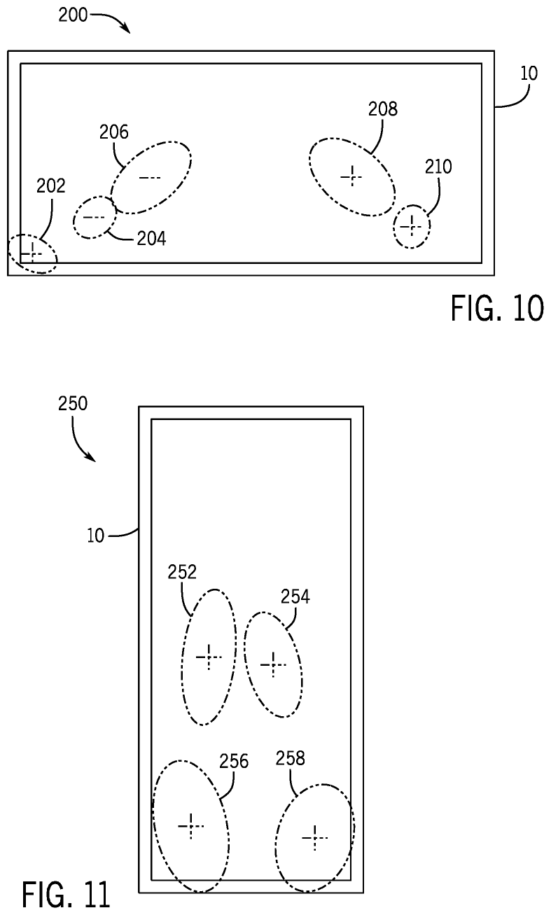

In process block 154, the antenna obstruction detecting logic 53 determines the user hand placement based on touch sensor data from touch sensors disposed on the electronic device 10. For example, touch sensors may be disposed in the bezel of the electronic device, under the display 18, and so on. FIG. 10 illustrates example touch sensor readings based on a first use case 200 of the electronic device 10. according to embodiments of the present disclosure. With respect to the use case 200 of FIG. 10, the electronic device 10 is held from the bottom in a horizontal or landscape orientation, such as when the electronic device 10 is used for video streaming, certain mobile gaming applications, and so on. For example, the use case 200 may correspond to the use case illustrated in FIG. 7. As described with respect to the process block 154 of FIG. 5, the touch sensors may determine hand and/or finger placement based on the sensor data at the regions 202, 204, 206, 208, and 210.

In query block 156, the antenna obstruction detecting circuitry may determine whether the user hand placement indicates antenna obstruction based on the calibration data received in the process block 152. The antenna obstruction detecting logic 53 may compare the user hand placement determined from the touch sensor data at the regions 202, 204, 206, 208 and 210 illustrated in FIG. 6 to the calibration data received in the process block 152 corresponding to that particular hand placement to determine an anticipated antenna obstruction caused by the particular hand placement. For example, the antenna obstruction detecting logic 53 may determine, based on the touch sensor data and the calibration data, that one or more antennas 55 disposed along the bottom edge and the side edges of the electronic device 10 (e.g., the antennas 55A, 55B, 55C, 55D, and 55E, as illustrated in FIG. 6) are obstructed and may estimate the impact on the antennas 55 (e.g., signal degradation) based on the obstruction.

In process block 158, the processor 12 may perform actions or execute preventative measures to mitigate, reduce, reduce, minimize, or eliminate the determined antenna obstruction due to the user hand placement. For instance, the processor 12 may cause the electronic device 10 to switch from one or more obstructed antenna (e.g., one or more of the antennas 55A, 55B, 55C, 55D, and 55E) to one or more unobstructed antennas (e.g., one or more of the antennas 55F, 55G, and 55H); manage antenna tuner settings to prioritize the unobstructed antennas; manage antenna 55/tuner settings to adjust values of a variable circuit components (e.g., adjusting the capacitance of one or more variable capacitors of antenna tuner or transceiver circuitry, adjusting the inductance of one or more variable inductors of antenna tuner or transceiver circuitry, and so on); manage antenna 55/tuner settings to adjust the frequency at which the antenna 55 transmits and/or receives signals; switching the electronic device 10 to a different radio access technology (e.g., Long Term Evolution (LTER) cellular network, New Radio (NR) cellular network, Frequency Range 1 (FR1) cellular network, Frequency Range 2 (FR2) cellular network, and so on); manage an antenna 55/tuner to switch to a different RF channel and/or RF band (e.g., frequency range) that may correspond to greater antenna efficiency; increase power to one or more unobstructed antennas or one or more signal processors corresponding to the one or more unobstructed antennas, reduce power consumption or turn off power to one or more obstructed antennas or one or more signal processors corresponding to the one or more obstructed antennas until the antenna or antennas becomes less obstructed or unobstructed if alternate antenna path and/or tuner options do not improve signal strength; perform other technology tradeoffs internally for the user without negatively impacting user experience; alert the user to possible postures or holds that may improve antenna performance; and/or gather statistics on user grip/usage patterns for better antenna placement/design in the future. In this manner, the method 150 may enable determining antenna obstruction and taking actions to mitigate the effects of the antenna obstruction.

FIG. 11 illustrates example touch sensor readings based on another use case 250 of the electronic device 10, according to embodiments of the present disclosure. With respect to FIG. 11, the electronic device 10 is held from the bottom while in a vertical orientation, and may correspond to usage of certain mobile device applications or functionalities such as text messaging applications, banking applications, social media applications, videoconferencing applications, and so on (e.g., as discussed with respect to FIG. 6). The antenna obstruction detecting logic 53 may compare the user hand placement determined from the touch sensor data at the regions 252, 254, 256, and 258.

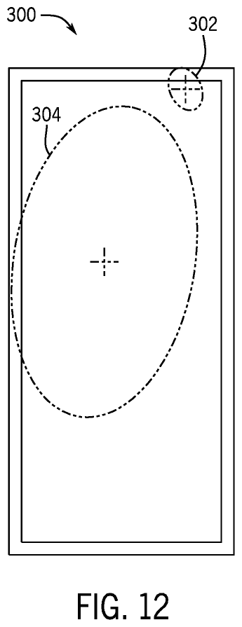

FIG. 12 illustrates example touch sensor readings based on yet another use case 300 of the electronic device 10, according to embodiments of the present disclosure. With respect to FIG. 12, the electronic device 10 is held against the face and/or head of the user, and may correspond to usage of certain applications such voice calling applications, speech-to-text applications, and so on (e.g., as discussed with respect to FIG. 8). The antenna obstruction detecting logic 53 may compare the user hand placement and head placement determined from the touch sensor data at the regions 302 and 304. The antenna obstruction detecting logic 53 may determine not only where on the electronic device 10 the head, hands, and/or fingers of the user are placed, but may also determine the amount of pressure applied by the head, hands, and/or fingers. Both the placement of the head, hands, and/or fingers and the amount of pressure applied by each may be stored as calibration data and used to determined degree of antenna obstruction.

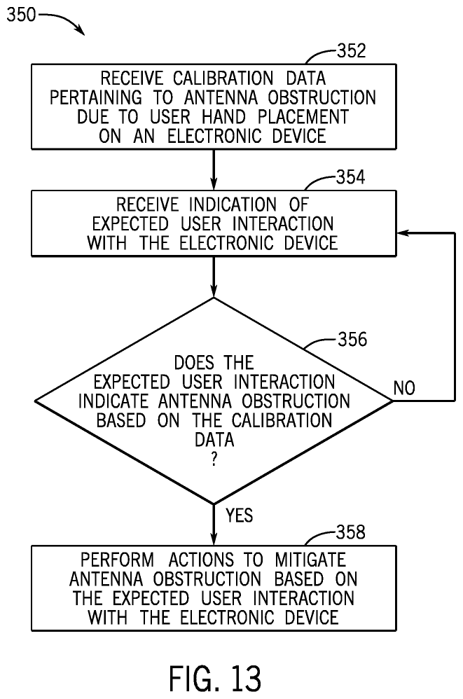

As previously mentioned, in some embodiments the touch-sensing algorithms may estimate user thumb/finger orientation and velocity, which may be used to predict future antenna obstruction (e.g., if the user's hand is in motion). FIG. 13 is a flowchart of a method 350 for predicting an upcoming user interaction with the electronic device 10 and performing mitigating actions to reduce or eliminate the negative impacts of the antenna obstruction, according to an embodiment of the present disclosure. Any suitable device (e.g., a controller) that may control components of the electronic device 10, such as the processor 12 and/or the antenna obstruction detecting logic 53, may perform the method 350. In some embodiments, the method 350 may be implemented by executing instructions stored in a tangible, non-transitory, computer-readable medium, such as the memory 14 or storage 16, using the processor 12. For example, the method 350 may be performed at least in part by one or more software components, such as an operating system of the electronic device 10, one or more software applications of the electronic device 10, and the like. While the method 350 is described using steps in a specific sequence, it should be understood that the present disclosure contemplates that the described steps may be performed in different sequences than the sequence illustrated, and certain described steps may be skipped or not performed altogether.

In process block 352, the antenna obstruction detecting logic 53 receives calibration data pertaining to antenna obstruction due to user hand placement on the electronic device 10, as discussed with respect to process block 152 of FIG. 9. In process block 354, the antenna obstruction detecting logic 53 receives an indication of expected user interaction with the electronic device 10. The indication of expected user interaction may include an indication that the user is going to select an application (e.g., by unlocking their phone), interact with an application (e.g., opening a game application), make or receive a voice call or video call, transition from a first application or functionality to a second application or functionality, and so on. For example, while the user is playing a mobile gaming application, the antenna obstruction detecting logic 53 may receive an indication that the user is receiving a voice call. Based on this indication, the antenna obstruction detecting logic 53 may predict that the user will transition from a first orientation and hand placement (e.g., the orientation and hand placements illustrated in FIGS. 7 and 10) to a second orientation and hand placement (e.g., the orientation and hand placements illustrated in FIGS. 8 and 12). As another example, the antenna obstruction detecting logic 53 may receive an indication that the user is receiving a voice call or opening a voice call application. Based on this indication, the antenna obstruction detecting logic 53 may determine that the user will hold the electronic device 10 similarly as to what is shown in FIG. 8 and FIG. 12.

In query block 356 the antenna obstruction detecting logic 53 determines whether the expected user interactions indicate antenna obstruction (e.g., a change in obstruction of one or more antennas, a change in degree of obstruction between one or more antennas, and so on) based on the calibration data. Continuing with the previous example, if the antenna obstruction detecting logic 53 predicts that the user will hold the electronic device 10 similarly as to what is shown in FIG. 8 and FIG. 12, the antenna obstruction detecting logic 53 may predict antenna obstruction based on the predicted hand placement and the calibration data corresponding to the predicted hand placement. That is, the antenna obstruction detecting logic 53 may predict that the antennas 55D, 55E, and 55F will be obstructed based on the calibration data.

In some embodiments, the antenna obstruction detecting logic 53 may determine which antennas are obstructed due to the current orientation and hand placement (e.g., at a first time N, where the orientation and hand placement is similar to that illustrated in FIGS. 7 and 10) based on the calibration data and, determine which antennas will be obstructed due to the expected orientation and hand placement (e.g., at a later time N+1 where the orientation and hand placement is similar to that illustrated in FIGS. 8 and 12) based on the calibration data. As will be discussed in greater detail below, the antenna obstruction detecting logic 53 may determine which antennas are obstructed based on a usage pattern associated with a user. The usage pattern may include hand placement, hand movement, device orientation, and so on based on specific user behavior and characteristics. If the antenna obstruction detecting logic 53 determines that there will be no new or additional antenna obstruction due to the expected user interaction, the antenna obstruction detecting logic 53 will continue to receive indications of expected user interactions with the electronic device 10 as appropriate.

However, if the antenna obstruction detecting logic 53 determines that there will be new or additional antenna obstruction, the processor 12 may, in process block 358, perform actions to mitigate antenna obstruction based on the expected user interaction with the electronic device 10. The mitigation actions may include those discussed with respect to the process block 158 of FIG. 9. This may enable the antenna obstruction detecting logic 53 to take mitigating actions prior to the degradation of antenna signal quality, and thus enhance performance of the electronic device 10 and improve user experience.

In some embodiments, the antenna obstruction detecting logic 53 may determine a user's usage characteristics and/or usage pattern based on the user's interaction with the electronic device 10. The electronic device 10 may determine the user characteristics and/or usage pattern based on, for example, a predetermined or dynamically determined user profile. The antenna obstruction detecting logic 53 may receive the indications from a user profile (e.g., stored in the memory 14). The profile may be a general user profile based on simulation and/or modelling determined during manufacturing. Usage characteristics may include orientation of the electronic device 10 and placement of the head, hands and/or fingers, and various other user behaviors corresponding to various interactions with the electronic device 10. Usage patterns may include a series of related characteristics (e.g., a second hand placement known to follow a first hand placement during particular device interactions). In some embodiments, a device interaction may include a manner in which the user is holding or gripping the electronic device 10 (e.g., a particular hand, finger, or head placement with respect to the electronic device 10) for a variety of usages of the electronic device. The device interaction may include an indication that the electronic device 10 is being used or will be used to make a voice call, a video call, or send or receive a text message based on user input; an indication that the electronic device is being used or will be used to play a mobile game based on user input; an indication that the electronic device is being used or will be used to interact with an application or functionality of the electronic device 10 based on user input; and/or an indication that the electronic device 10 is being accessed or will be accessed based on user input.

In other embodiments, the user's usage pattern may be determined via machine-learning. As used herein, machine-learning may refer to algorithms and statistical models that computer systems (e.g., including the electronic device 10) use to perform a specific task with or without using explicit instructions. For example, a machine-learning process may generate a mathematical model based on a sample of data. known as “training data,” in order to make predictions or decisions without being explicitly programmed to perform the task.

Depending on the inferences to be made, the processor 12 and/or the antenna obstruction detecting logic 53 may implement different forms of machine-learning. For example, in some embodiments (e.g., when particular known examples exist that correlate to future predictions or estimates that the machine-learning engine may be tasked with generating), a machine-learning engine may implement supervised machine-learning. In supervised machine-learning, a mathematical model of a set of data contains both inputs and desired outputs. This data is referred to as “training data” and may include a set of training examples. For example, training data may include sensor data readings corresponding to various hand placements and usage patterns associated with various device interactions (e.g., such as those shown in FIGS. 6-8 and 10-12). Each training example may have one or more inputs and a desired output, also known as a supervisory signal. In a mathematical model, each training example is represented by an array or vector, sometimes called a feature vector, and the training data is represented by a matrix. Through iterative optimization of an objective function, supervised learning algorithms may learn a function that may be used to predict an output associated with new inputs. An optimal function may allow the algorithm to correctly determine the output for inputs that were not a part of the training data. An algorithm that improves the accuracy of its outputs or predictions over time is said to have learned to perform that task.

Supervised learning algorithms may include classification and regression techniques. Classification algorithms may be used when the outputs are restricted to a limited set of values, and regression algorithms may be used when the outputs have a numerical value within a range. Similarity learning is an area of supervised machine-learning closely related to regression and classification, but the goal is to learn from examples using a similarity function that measures how similar or related two objects are. Similarity learning has applications in ranking, recommendation systems, visual identity tracking, face verification, and speaker verification.

Additionally and/or alternatively, in some situations, it may be beneficial for the machine-learning engine to utilize unsupervised learning (e.g., when particular output types are not known). Unsupervised learning algorithms take a set of data that contains only inputs (e.g., sensor data), and find structure in the data, like grouping or clustering of data points. The algorithms, therefore, learn from test data that has not been labeled, classified, or categorized. Instead of responding to feedback, unsupervised learning algorithms identify commonalities in the data and react based on the presence or absence of such commonalities in each new piece of data.

That is, the machine-learning engine may implement cluster analysis, which is the assignment of a set of observations into subsets (called clusters) so that observations within the same cluster are similar according to one or more predesignated criteria, while observations drawn from different clusters are dissimilar. Different clustering techniques make different assumptions on the structure of the data, often defined by some similarity metric and evaluated, for example, by internal compactness, or the similarity between members of the same cluster, and separation, the difference between clusters. In additional or alternative embodiments, the machine-learning engine may implement other machine-learning techniques, such as those based on estimated density and graph connectivity.

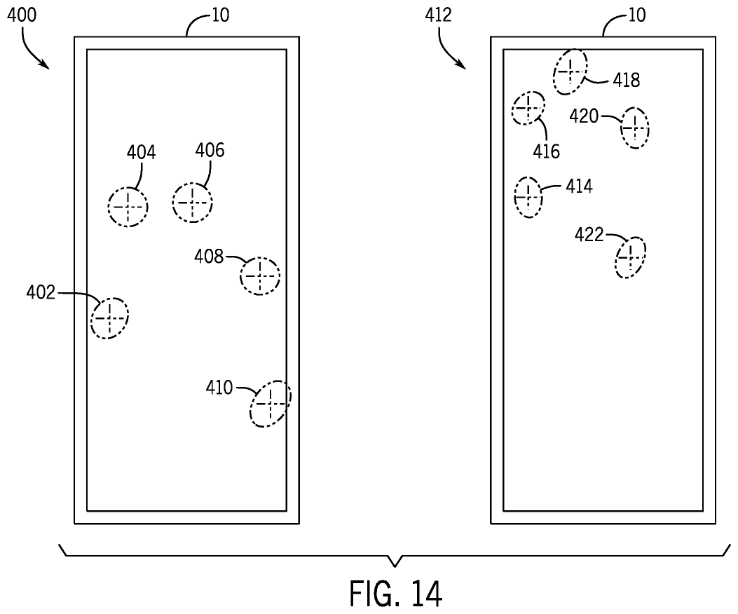

FIG. 14 illustrates a usage pattern (e.g., a hand placement pattern) for a user interaction with the electronic device 10 at different times. Hand placements 400 and 412 may correspond to the use cases illustrated in FIGS. 6 and 11. The hand placement 400 includes regions 402, 404, 406, 408, and 410 that may indicate sensor data readings for a device usage at a first time. A user profile may indicate to the antenna obstruction detecting logic 53 that, based on the hand placement 400 and determined usage patterns associated with the user's behavior, the user is likely going to transition to the hand placement 412, including regions 414, 416, 418, 420 and 422 that may indicate sensor data readings for the device usage at a second time. Thus, the antenna obstruction detecting logic 53 can, based on the indications received from the user profile, determine that the hand placement 412 is likely to follow the hand placement 400.

For example, the antenna obstruction detecting logic 53 may determine that the hand placement 400 indicates the user unlocking the electronic device 10 at a first time. The antenna obstruction detecting logic 53 may predict, based on the user profile, that the hand placement 412 will occur at a second time. As another example, the antenna obstruction detecting logic 53 may receive an indication that the user has accessed a particular application. The antenna obstruction detecting logic 53 may predict that, based on the indication and based on the user profile, that the upcoming usage pattern include the hand placement 400 at a first time and the hand placement 412 at a second time. Based on this determination, the processor 12 may perform mitigating actions to mitigate antenna signal quality degradation based on the usage pattern.

As previously stated, in some embodiments, the antenna obstruction detecting logic 53 may receive the indications based on machine learning. For example, the antenna obstruction detecting logic 53 may use machine learning to determine the user profile used to predict usage patterns for a particular user. The antenna obstruction detecting logic 53 may determine user interaction with the electronic device 10 and compare the user profile with the calibration data.

As another example, the antenna obstruction detecting logic 53 may determine expected user interaction with the electronic device based on the specific type of application or functionality that the electronic device 10 and user are engaged in. For instance, certain mobile gaming applications may utilize touchscreen simulations of buttons or directional pads, while some may not. The antenna obstruction circuitry may receive an indication of which type of touchscreen functionality each application utilizes, and determine existing or expected antenna obstruction due to the various functionalities.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A device, comprising:
a plurality of touch sensors;
one or more antennas; and
processing circuitry coupled to the plurality of touch sensors and the one or more antennas, the processing circuitry configured to:
receive touch sensor data from the plurality of touch sensors;
receive an indication of device interaction; and
perform an action based on a prediction of antenna occlusion based on the indication of device interaction, wherein the action is configured to mitigate effects of the antenna occlusion.

2. The device of claim 1, wherein the processing circuitry is configured to receive an indication of an impending hand placement associated with the device interaction.

3. The device of claim 1, wherein the indication of device interaction comprises an indication that the device will be used to make a voice call.

4. The device of claim 1, wherein the indication of device interaction comprises an indication that the device will be used to play a mobile game.

5. The device of claim 3, wherein the indication of device interaction comprises an indication that the device is being accessed.

6. The device of claim 1, wherein performing the action to mitigate the effects of the antenna occlusion comprises switching from an occluded antenna to a non-occluded antenna, prioritizing the non-occluded antenna, switching to a different radio frequency band, triggering an alert indicating postures or hand placements that may reduce the antenna occlusion, or any combination thereof.

7. A method, comprising:
receiving, via antenna obstruction detecting logic, touch sensor data from an electronic device;
receiving, at the antenna obstruction detecting logic, a usage pattern based on the touch sensor data; and
performing, via a processor, one or more actions based on a prediction of antenna occlusion based on the usage pattern, the one or more actions configured to mitigate effects of the antenna occlusion.

8. The method of claim 7, wherein the one or more actions comprising powering off one or more occluded antennas, reducing power to the one or more occluded antennas, increasing power to one or more non-occluded antennas, or any combination thereof.

9. The method of claim 7, wherein receiving the touch sensor data comprises receiving first touch sensor data at a first time and receiving second touch sensor data at a second time.

10. The method of claim 7, comprising receiving an indication of upcoming user interaction with the electronic device indicative of the usage pattern, wherein performing the one or more actions to mitigate effects of the antenna occlusion is based on the indication.

11. The method of claim 10, wherein the indication of the upcoming user interaction with the electronic device comprises an indication of a transition from a first application to a second application.

12. The method of claim 10, wherein the indication of the upcoming user interaction with the electronic device comprises an indication of a transition from a first device orientation to a second device orientation.

13. The method of claim 10, wherein the indication of the upcoming user interaction comprises an indication that the user is making or receiving a voice call.

14. The method of claim 10, wherein the indication of the upcoming user interaction comprises an indication that the user is playing a game on the electronic device.

15. A tangible, non-transitory, computer-readable medium comprising computer-readable instructions that cause one or more processors to:
receive calibration data corresponding to antenna occlusion;
receive touch sensor data from a plurality of touch sensors;
receive an indication of a device interaction;
predict antenna occlusion based on the indication and the calibration data; and
execute a preventative measure to reduce or eliminate effects of the antenna occlusion.

16. The tangible, non-transitory, computer-readable medium of claim 15, wherein the calibration data comprises data corresponding to antenna occlusion due to device orientation.

17. The tangible, non-transitory, computer-readable medium of claim 15, wherein the calibration data comprises data corresponding to antenna occlusion due to hand placement or finger placement with respect to an electronic device, or both.

18. The tangible, non-transitory, computer-readable medium of claim 15, wherein the calibration data comprises data corresponding to antenna occlusion due to head position with respect to an electronic device.

19. The tangible, non-transitory, computer-readable medium of claim 15, wherein the indication comprises a usage pattern.

20. The tangible, non-transitory, computer-readable medium of claim 15, wherein the preventative measure to reduce or eliminate the effects of the antenna occlusion comprises powering off one or more occluded antennas, reducing power to the one or more occluded antennas, increasing power to one or more non-occluded antennas, or any combination thereof.
